(19) United States
(12) Patent Application Publication
(10) Pub. No.: US 2014/0172891 A1
(43) Pub. Date: Jun. 19, 2014

(54) METHODS AND SYSTEMS FOR DISPLAYING LOCATION SPECIFIC CONTENT

(71) Applicant: UNITED VIDEO PROPERTIES, INC., Santa Clara, CA (US)

(72) Inventors: William Amidei, La Jolla, CA (US); Paul Jensen, Menlo Park, CA (US)

(73) Assignee: UNITED VIDEO PROPERTIES, INC., Santa Clara, CA (US)

(21) Appl. No.: 13/716,423

(22) Filed: Dec. 17, 2012

(51) Int. Cl. G06F 17/30

(52) U.S. Cl. CPC G06F 17/30259
USPC 707/758

(57) ABSTRACT

Methods and systems are described herein for selecting a media asset for presentation on a user device based on the type of location in which the user device is located. For example, a media guidance application may receive data describing the location of a user device. Upon processing the data, the media guidance application may detect objects at the location. By cross-referencing the detected objects with a database indicating types of locations in which the detected objects are typically found, the media guidance application determines a location type for the location of the user device. The media guidance application then selects media assets appropriate for the location for presentation to the user.

### BACKGROUND

Media assets (e.g., television programs, movies, music, videogames, smartphone applications, etc.) accessed by a user often tend to vary according to the location of the device upon which the user is accessing the media asset. For example, the user may typically request access to media assets having similar qualities whenever the user is in a particular location. Furthermore, the qualities of media assets requested by the user in one location may differ from those of media assets requested by the user in a different location. For example, the user may typically request access to media assets featuring cooking programming while in the kitchen, but may typically request access to media assets featuring theatrical programming while in a living room.

Despite typically requesting access to media assets having similar qualities while in a particular location, currently users are not able to manually or automatically designate the location of a user device for the purposes of receiving media assets, or recommendations of media assets, based on the location of the user device used to receive the media assets.

### SUMMARY OF THE DISCLOSURE

Accordingly, methods and systems are described herein for selecting a media asset for presentation on a user device based on the type of location in which the user device is located. Specifically, a media guidance application may receive data (e.g., a panoramic image) describing the location (e.g., a room of a private residence) of a user device (e.g., a computer). Upon processing the data, the media guidance application may detect objects (e.g., furniture) at the location. By cross-referencing the detected objects with a database indicating types of locations in which the detected objects are typically found (e.g., rooms of a private residence typically featuring the detected furniture), the media guidance application determines a location type (e.g., a kitchen, living room, bedroom, garage, etc.) for the location of the user device. The media guidance application then selects media assets, or makes media asset recommendations, appropriate for the location for presentation to the user.

In some embodiments, the media guidance application may receive data (e.g., multiple images and/or videos) describing multiple locations in a household (e.g., several rooms of a private residence). The media guidance application may determine (e.g., via view synthesis techniques) the association between the multiple locations (e.g., how the rooms connect to one another within the private residence) based on the received data. Based on the associations, the media guidance application may generate a map (e.g., a blueprint of the private residence) and determine the location types of each location based at least in part on the map (e.g., select a location type based on the size, position, and shape of one location in the private residence relative to the size, position, and shape of another location in the private residence). Based on the determined location types, the media guidance application may transmit media assets, or media asset recommendations, specific to each location to user devices in the respective locations.

In some embodiments, the media guidance application may generate and store data one or more images (e.g., a panoramic image) and/or videos describing multiple locations in a household (e.g., several rooms of a private residence) and any objects identified in any of the multiple locations as well as the determined location type of each of the multiple locations in a database. Upon activation of a user device, the media guidance application implemented on a user device may capture an image of its current location or the location of another device. The image (including any object identified within the image) may be cross-referenced with the database to match the object in the image with an object previously identified in one of the multiple locations stored on the database. Based on matching the object in the image to one of the objects stored in the database, the media guidance application may determine the current location and/or location type, including any preferences associated with the location and/or location type, of the user device or the other image.

In some embodiments, the media guidance application may also receive data (e.g., an image) associated with one or more user devices (e.g., a television, a tablet computer, a smartphone, etc.). The media guidance application may cross-reference the data in a database indicating operational parameters (e.g., whether or not the television supports high definition programming) associated with the user device. The media guidance application may determine the operational parameters based on the cross-reference and select media content for presentation based on the determined operational parameters.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance application that may be used to display media assets in accordance with some embodiments of the disclosure;

FIG. 2 shows another illustrative example of a media guidance application that may be used to display media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is an illustrative example of an image of a location of a user equipment device that may be used to select a media asset for presentation to a user based at least in part on the location type in accordance with some embodiments of the disclosure;

FIG. 6 is an illustrative example of a data structure that may be used to identify an object in a location in accordance with some embodiments of the disclosure;

FIG. 7 is a flowchart of illustrative steps for selecting a media asset for presentation to a user based at least in part on the location type in accordance with some embodiments of the disclosure; and

FIG. 8 is a flowchart of illustrative steps for analyzing a location image used to select a media asset for presentation to a user based on a location profile in accordance with some embodiments of the disclosure.

### DETAILED DESCRIPTION OF DRAWINGS

The amount of content available to users in any given content delivery system can be substantial. Consequently, many users desire a form of media guidance through an interface that allows users to efficiently navigate content selections and easily select, recommend, and/or transmit content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

Methods and systems are described herein for selecting, recommending, and/or transmitting a media asset for presentation on a user device based on the type of location in which the user device is located. For example, a media guidance application may receive data describing the location of a user device. Upon processing the data, the media guidance application may detect objects at the location. By cross-referencing the detected objects with a database indicating types of locations in which the detected objects are typically found, the media guidance application determines a location type for the location of the user device. The media guidance application then selects media assets appropriate for the location for presentation to the user.

In some embodiments, the media guidance application may receive one or more types of data describing the location of a user device (e.g., via a content capture application and/or device as described below). For example, in some embodiments, the media guidance application may receive an image, a video, an audio sample, a textual description, or any other type of code and/or signal suitable for describing the location, or objects in the location, of the user device.

As used herein, a “location” refers to the current geographical coordinates of the user device and may be described as having a location type. As used herein, a “location type” refers to a designation describing the place or structure that occupies the current geographical coordinates associated with the location. For example, a location may be described as a structure (e.g., including, but not limited to, a public building, a private residence, an office building, a restaurant, movie theatre, a vehicle, a bridge, a museum, a road, a driveway, a sidewalk, etc.), a room or compartment of a structure (e.g., including, but not limited to, a bedroom of an adult, a bedroom of a child, a kitchen, a living room, a bathroom, a garage, or any other designation which may describe a room of a structure), and/or any other physical setting, which may be described by a common designation (e.g., including, but not limited to, a yard, a park, a landmark, whether natural or man-made, a hiking trail, a body of water, a municipality, etc.).

In some embodiments, upon processing the received data describing the location of a user device, the media guidance application may detect objects at the location. As used herein, an “object” refers to anything situated at the location that may influence a determination of a location type associated with the location. For example, in an embodiment where the location is in a household, an object may be a person at the location, furniture at the location, household goods at the location, decorations at the location, fixtures at the location, and/or floor coverings at the location as the aforementioned things may affect the location type as determined by the media guidance application. In some embodiments, an object may also refer to sounds or noises received at a location, which may be processed by the media guidance application to determine a location type. In some embodiments, the determination of a location type may also be affected by active (e.g., user inputs describing the location) or passive (e.g., monitoring user actions such as the characteristics of media assets accessed at the location to describe the location) user actions.

By cross-referencing the detected objects with a database indicating types of locations in which the detected objects are typically found, the media guidance application determines a location type for the location of the user device. The media guidance application then selects media assets appropriate for the location for presentation to the user. For example, in some embodiments, the media guidance application may identify an object in the data received describing the location (e.g., an image) of a user equipment device to be a sofa. The media guidance application may input “sofa” into a lookup table database, for example, located on local storage (e.g., on the device upon which the media guidance application is implemented) or on remote storage (e.g., on a device or place accessible via the Internet) to determine the location type in which sofas are typically found (e.g., living rooms). Based on the determination that sofas are typically found in a particular location type (e.g., a living room), the media guidance application determines the location type for the location of the user equipment device is the particular location type. In response, the media guidance application selects, recommends, and/or transmits one or more media assets for presentation to the user based on media assets typically viewed in the particular location type.

In another example, the media guidance application may identify an object in data describing a location to be a crib. The media application may determine (e.g., via cross-referencing a database as discussed above) that cribs are typically found in rooms of young children. Based on the determination that cribs are typically found in rooms of children, the media guidance application may determine the location type for the location of the user equipment device is a room of a child, and select age-appropriate media assets for presentation or auto-select parental controls suitable for a child and block access to unsuitable content (e.g., media assets featuring alcohol).

In some embodiments, the media guidance application may identify multiple objects in data received describing a location. In such cases, the media guidance application may generate a location profile. As used herein, a “location profile” refers to a collection of information used by the media guidance application to determine a location type for the location. For example, in some embodiments, the data received by the media guidance application describing the location may feature several objects, which may each be associated with different location types. For example, the media guidance application may determine that a sink is located at the location. A sink may be associated with both a kitchen and a bathroom; therefore, the media guidance application may determine an additional object located in the location. Upon determining that a refrigerator is also located at the location, the media guidance application may determine that the location type is a kitchen as a sink and refrigerator (or a refrigerator only) are typically found in a kitchen and not a bathroom.

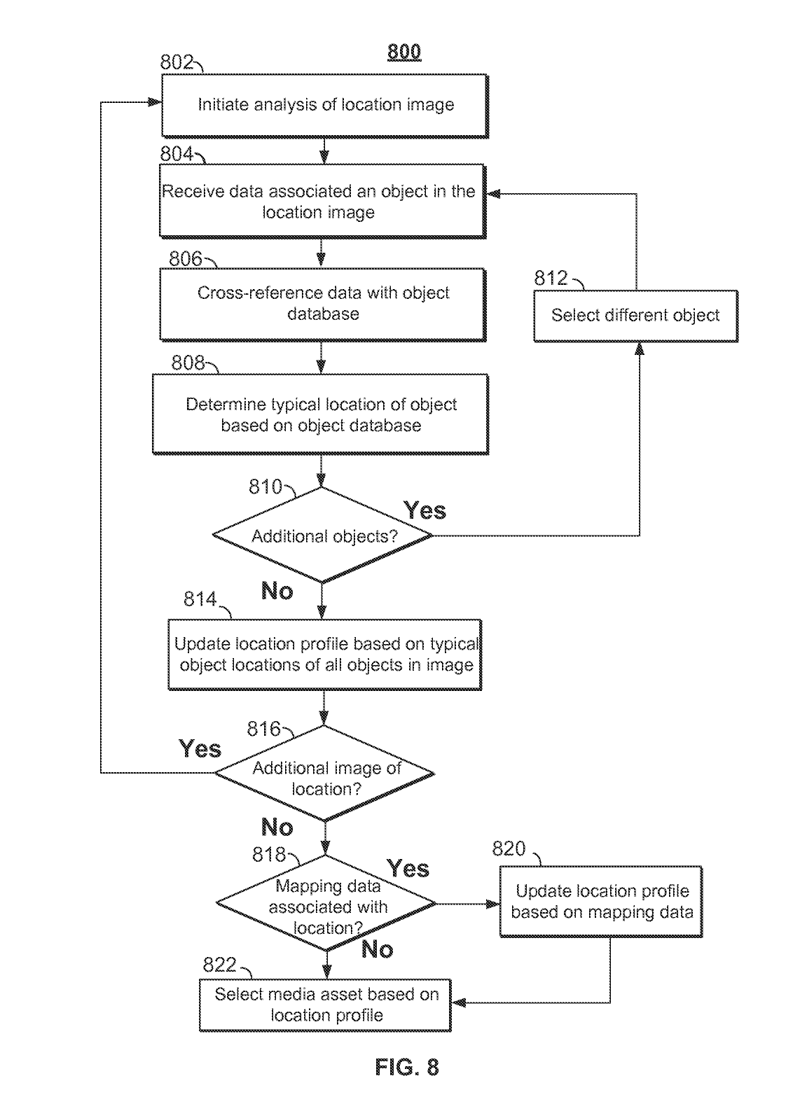

In some embodiments, the media guidance application may use multiple types of received data to determine the particular type of a location. For example, a first type of data (e.g., an image of a desk) received by the media guidance application may, upon cross-referencing with a database, indicate one particular type of location (e.g., a home-office). However, additional information (e.g., additional factors as described below) received (e.g., audio analysis of conversations occurring at the location, phone and/or tax records associated with the location, and/or user inputs) may indicate an alternative and/or additional designation for the location (e.g., a non-residential office). The multiple types of data may all be contained in the location profile, which may be processed by the media guidance application (e.g., as shown and discussed in FIG. 8 below).

In some embodiments, a media guidance application may use a content recognition module or algorithm to determine the objects in received data. The content recognition module may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to determine the objects and/or relationship between locations in received data. For example, the media guidance application may receive data in the form of a video. The video may include a series of frames. For each frame of the video, the media guidance application may use a content recognition module or algorithm to determine the people or furniture in each of the frame or series of frames. In addition, the content recognition module or algorithm may also locate the boundaries (e.g., the walls, ceilings, floors, doors, etc.) necessary to generate a mapping (e.g., via view synthesis techniques) of one or more locations (e.g., in order to create a blueprint of a household or structure containing several locations).

In some embodiments, the content recognition module or algorithm may also include speech recognition techniques, including but not limited to Hidden Markov Models, dynamic time warping, and/or neural networks (as described above) to translate spoken words into text and/or processing audio data. The content recognition module may also combine multiple techniques to determine the objects and/or relationship between locations in received data.

In addition, the media application may use multiple types of optical character recognition and/or fuzzy logic, for example, when processing keyword(s) retrieved from data (e.g., textual data, translated audio data, user inputs, etc.) associated with a location (or when cross-referencing various types of data in databases indicating the different objects associated with different location types). For example, if the particular data received is textual data, using fuzzy logic, the media guidance application (e.g., via a content recognition module or algorithm incorporated into, or accessible by, the media guidance application) may determine two fields and/or values to be identical even though the substance of the data or value (e.g., two different spellings) is not identical. In some embodiments, the media guidance application may analyze particular received data of a data structure or media asset frame for particular values or text. The data received could be associated with characteristics, additional information, and/or any other data required for the function of the embodiments described herein. Furthermore, the data could contain values (e.g., the data could be expressed in binary or any other suitable code or programming language).

In some embodiments, the media guidance application may use multiple sources and/or methods to determine what media assets to select, recommend, and/or transmit media assets appropriate for the location upon determining the location type. For example, the media guidance application may cross-reference one or more databases that contain information about the media assets and/or types of media assets preferred by users at a particular location type. For example, the media guidance application may retrieve a list of media assets appropriate for a particular location type from one or more local or remote storage locations.

Additionally or alternatively, the media guidance application may retrieve one or more user profiles, which indicate the media assets and/or types of media assets preferred by a particular user at a particular location type. For example, the media guidance application may retrieve a user profile that indicates that a particular user prefers to receive traffic reports when his/her location type is a vehicle, prefers to receive news articles when his/her location type is an office, and/or prefers to receive streaming music when his/her location type is a gym.

For example, the media guidance application may determine that particular objects (e.g., a crib) at a location indicate a particular location type (e.g., a bedroom) and/or a particular occupant of the location type (e.g., a young child). The media guidance application may, therefore, adjust the media assets and/or types of media assets selected, recommended, and/or transmitted to be more in line with the interests of a young child (e.g., cartoons and advertisements related to toys may be displayed). The media guidance application may also activate (or deactivate) particular features (e.g., parental control settings), display options (e.g., maximum volume settings), or viewing policies (e.g., time periods in which the user device may not be accessed such as after a child's bedtime) based on the indicated location type and/or occupant. For example, a parental control and/or content control setting may be activated upon receiving an indication of the presence of an under-age occupant in a location. In another example, upon determining that a location features objects (e.g., movie posters of a particular genre) that may indicate an interest of a user in particular media assets (e.g., media assets of the same genre as the movie posters), the media guidance application may select, recommend, and/or transmit the media assets and/or types of media assets of the indicated genre.

In some embodiments, the media assets (e.g., advertisements) that may be selected, recommended, and/or transmitted to a user may be associated with a data structure that describes the content, context, or target location type or audience for the media asset. The data structure may be stored locally or remotely, and may be stored either together or separately from its associated media asset. For example, in some embodiments, the media asset may be stored on a remote server (e.g., content source 416 (FIG. 4)) and the data structure associated with the media asset may be stored on a different remote server (e.g., media guidance data source 418 (FIG. 4)).

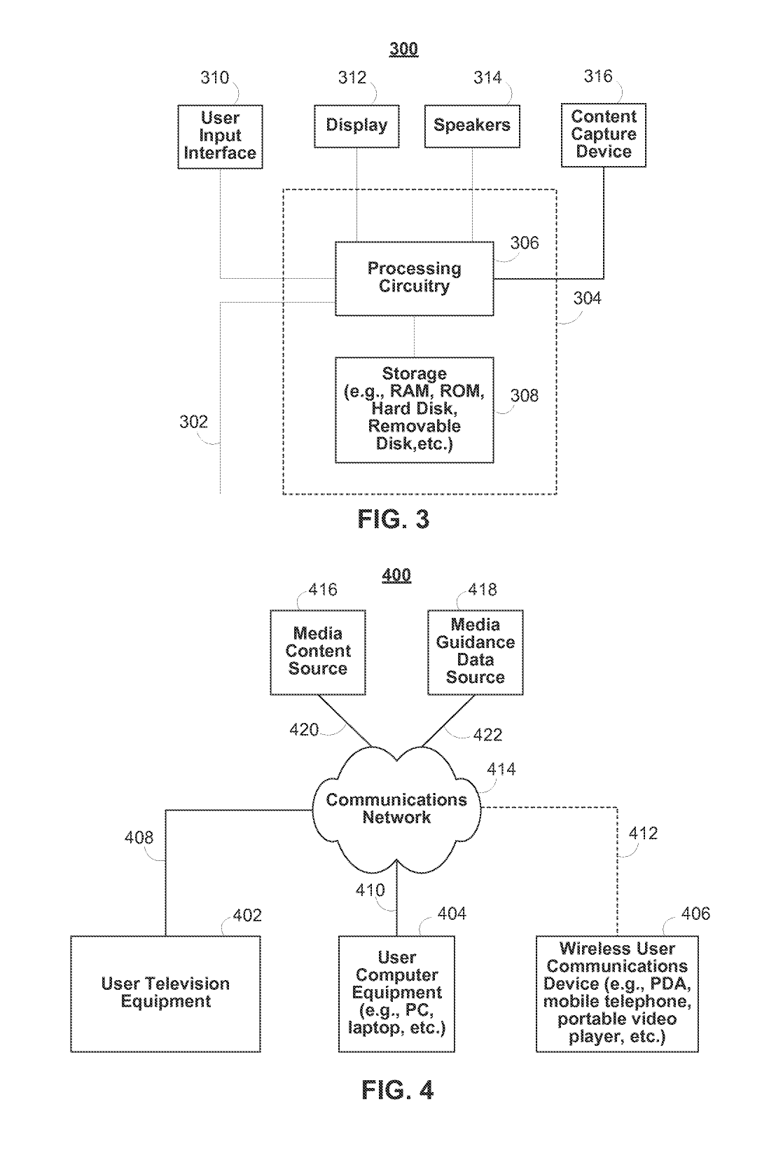

For example, the data structure associated with the advertisement may describe the content (e.g., the genre, rating, etc.) of a media asset. The media guidance application may issue a request for, or retrieve (e.g., via processing the data structure associated with the media asset using control circuitry 304 (FIG. 3)), a media asset that is appropriate for a particular location type and/or user (e.g., a bedroom for a young child). For example, a remote server hosting the media assets and/or the data structures associated with the media assets may receive instructions (e.g., requirements for a media asset) from a media guidance application describing the media asset that is needed (e.g., based on a location type). The server may cross-reference a database of various data structures until a data structure having the requested requirements is located. The located media asset may then be transmitted to the media guidance application for display in the user device.

In some embodiments, the media guidance application may generate and store data (e.g., a location profile) associated with one or more locations (e.g., individual rooms) located within another location (e.g., a house or office building) and any objects (e.g., a bed, a desk, etc.) identified in any of one or more locations located within the other location as well as the determined location type of each of the one or more locations.

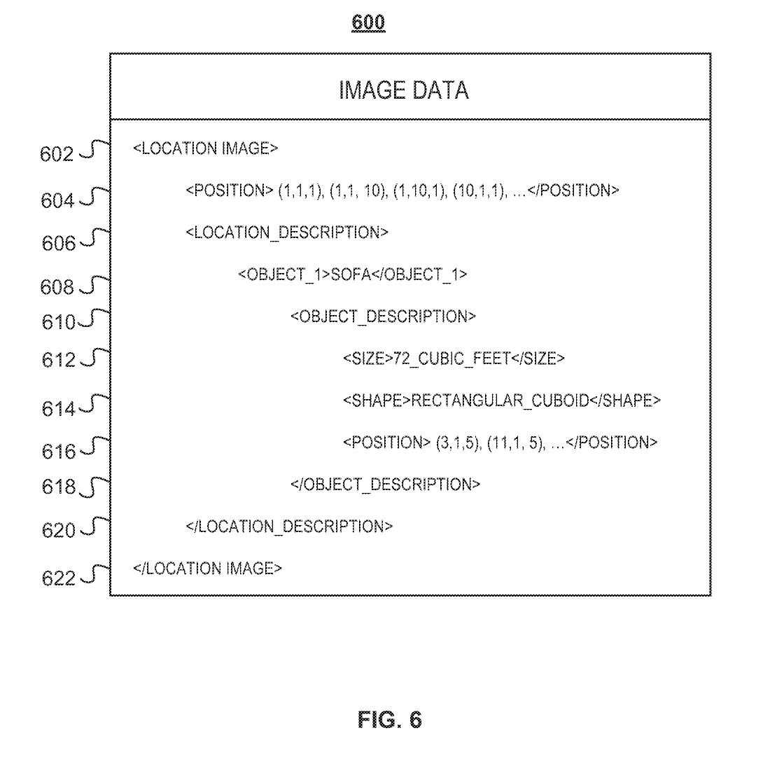

In some embodiments, the data generated as described above and below may be stored in a location database located either locally (e.g., storage 308 (FIG. 3) of user equipment device 402, 404, and/or 406 (FIG. 4)) or remotely on a server accessed via the Internet (e.g., media guidance data source 418 (FIG. 4)) to the user device. The location database may index (e.g., as a lookup table) the location profiles, which may include any objects, including user devices, identified in each of the one or more locations, floor plans associated with the one or more locations, and/or any determined location types for the one or more locations in the location database by a name for the location (e.g., as determined by a user input delivered via user input interface 310 (FIG. 3) or as determined based on position data associated with each of the one or more locations (e.g., field 604 (FIG. 6)).

Upon activation of a user device or upon a user input request to capture data, the media guidance application (e.g., via control circuitry 304 (FIG. 3)) implemented on a user device (e.g., user equipment device 402, 404, and/or 406 (FIG. 4)) may capture data (e.g., an image describing the current location, objects, including other user devices, in the current location of the user device, position data associated with the current position of the user device, a floor plan associated with the current position, or any other information necessary for the functioning of the media guidance application) describing its current location.

In response to receiving the data describing the current location of the user device or another user device identified in the received data, the media guidance application may cross-reference the received data with the data describing the one or more locations previously stored in the location database in order to match the object or location in the received data with an object or location in the location database.

In some embodiments, the location database may also store other information associated with one or more devices. For example, a location profile may be associated with a household or residence. Information obtained from a cable provider (or via a third party, for example, a credit card statement reflecting a cable subscription payment) may indicate that the user has only one device currently receiving cable television. By including the other information associated with one or more devices in the location database, the media guidance application may additionally determine that the user device identified in the capture data is the only user device in the household. Because there is only one user device in the household, the selection, recommendation, and/or transmission of one or more media assets and/or advertisement for presentation to the user based on the media assets and/or advertisements, or type of media assets and/or advertisements, appropriate for the particular location and/or location type may be adjusted accordingly.

In another example, media guidance application may detect, and/or the location database may store information associated with, other user devices within the household or location. For example, the user device upon which the media guidance application is implemented may detect (e.g., via control circuitry 304 (FIG. 3)) other devices connected to the user device (or connected to another device) via short-range point-to-point communication paths, such as USB cables, IEEE 1394 cables, wireless paths (e.g., Bluetooth, Xbox SmartGlass, infrared, IEEE 802-11x, etc.), or other short-range communication via wired or wireless paths as discussed below. In some embodiments, the presence of other devices may be included within the information associated with one or more devices in the location database and may affect the selection, recommendation, and/or transmission of one or more media assets and/or advertisement for presentation to the user based on the media assets and/or advertisements, or type of media assets and/or advertisements, appropriate for the particular location and/or location type. For example, one or more media assets may be delivered in concert to multiple devices in one location (e.g., as a second screen device as described herein).

Upon matching the object or location in the received data with an object or location in the location database, the media guidance application determines the current location of the user device based on the location name indicated in the location database as corresponding to the matched object or location. Having determined the current location of the user device based on the cross-reference, the media guidance application may proceed to select, recommend, and/or transmit one or more media assets and/or advertisement for presentation to the user based on the media assets and/or advertisements, or type of media assets and/or advertisements, appropriate for the particular location and/or location type.

In some embodiments, the media assets and/or advertisements, or type of media assets and/or advertisements selected, recommended, and/or transmitted to one user device at a location or location type may also be selected, recommended, and/or transmitted to other user devices determined to be in the same location. For example, a sessile device (e.g., a television wired in a particular position) identified in data captured by the media guidance application implemented on a user device, may be automatically (e.g., via referencing the location database) associated with the location type determined for the position of the user device at the time the data was captured. Other devices detected to be in the same location (e.g., via wireless communication) may also be automatically associated with the same location type. By associating captured data with multiple devices, particularly sessile devices, the need to update or repeatedly capture data is minimized.

In some embodiments, the media guidance application may determine the operational parameters of a user device and adjust the media assets and/or types of media assets accordingly. As used herein, “operational parameters” refers to the characteristics and properties associated with the performance capabilities and requirements of a device. For example, operational parameters may include formats, display qualities, or other features (e.g., 3D display abilities, surround sound audio, screen size limitations, etc.) that the user device is capable of processing and/or displaying (e.g., whether or not the user device supports high definition programming or a particular codec).

In some embodiments, to determine the operational parameters, the media guidance application may determine the type of user device (e.g., television, smartphone, computer, etc.) and well as the brand and model of the user device. The media guidance application may then cross-reference the type, brand, and model information in a database indicating the operational parameters (e.g., whether or not a particular model of a particular brand of a particular type of device supports a particular type of programming). Based on the determined operational parameters, the media guidance application may adjust the media assets and/or types of media assets accordingly.

In some embodiments, the media guidance application may further adjust the media assets and/or types of media assets selected, recommended, and/or transmitted based on additional factors such as the time, date, number of users present, data received from other sources (e.g., GPS data, tax records, user inputs, etc.) and/or the identity of users indicated in the received data. As used herein, an “additional factor” refers to any characteristics other than data received from a content capture device used for determining a location type of a location that may affect the selection, recommendation, and/or transmission of media assets and/or types of media assets to a user equipment device. For example, the media guidance application may select, recommend, and/or transmit different media assets and/or types of media assets to the same device at the same location at different times even though the data received (e.g., an image containing an object) is the same. For example, whereas the media guidance application may select a family movie for presentation on a user equipment device determined to be in a living room before a particular time (e.g., as determined by a time keeping device incorporated into or accessible by the media guidance application) or if children are present (e.g., as determined by a content recognition module identifying the presence of children), the media guidance application may select a horror movie for presentation after a particular time or if children are not present.

In some embodiments, the media guidance application may identify a likelihood that a particular user is accessing the user equipment device, or that a particular user equipment device is in a location having a particular location type. For example, the likelihood may indicate with a particular percentage that the location type is a kitchen and/or not a bathroom. For example, the media guidance application may assign a weighted value to the different types of data received (e.g., an image indicating an object, an audio sample identified to be from a particular user, a textual input describing the location, etc.) and/or additional factors (e.g., the type of media assets typically viewed on the user equipment device, the particular users typically accessing the user equipment device, etc.). The weighted values may then be compiled and/or normalized (e.g., indicating a value between one and one-hundred) to give a likelihood that a particular user is accessing the user equipment device or that a particular user equipment device is in a location having a particular location type.

The determined likelihood may then be compared to a threshold likelihood (e.g., retrieve from local or remote storage). If the determined likelihood is greater than the threshold likelihood, the media guidance application may determine that a particular user is accessing the user equipment device or that a particular user equipment device is in a location having a particular location type. If the determined likelihood is not greater than the threshold likelihood, the media guidance application may not determine that a particular user is accessing the user equipment device or that a particular user equipment device is in a location having a particular location type.

If the likelihood determined by the media guidance application cannot exceed the retrieved threshold likelihood, the media guidance application may select, recommend, and/or transmit media assets and/or types of media assets that are appropriate for several locations or users. For example, if the likelihood (e.g., indicating that the location type is a kitchen and not a bathroom) determined by media guidance application does not exceed a threshold likelihood, the media guidance application may select, recommend, and/or transmit media assets and/or types of media assets that are appropriate for both a kitchen and a bathroom.

If the likelihood determined by the media guidance application exceeds the retrieved threshold likelihood, the media guidance application may select, recommend, and/or transmit media assets and/or types of media assets that are appropriate for only the determined location or user. For example, if the likelihood (e.g., indicating that the location type is a kitchen and not a bathroom) determined by media guidance application does exceed a threshold likelihood, the media guidance application may select, recommend, and/or transmit media assets and/or types of media assets that are appropriate for only a kitchen.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, a user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

In some embodiments, the user equipment device may have a content capture device incorporated within the user equipment device and/or accessible to the user equipment device. In some embodiments, the media guidance application may have a content capture device incorporated within the device and/or accessible to the device, whether or not the device is a user equipment device, upon which the media guidance application is implemented.

As used herein, a “content capture device” refers to a device capable of capturing data (e.g., data describing a location of a user device) and transmitting the data to the media guidance application. In some embodiments, the content capture device may incorporate one or more components or sensors (e.g., components or sensors capable of capturing image, audio, video, and/or any other type of data needed for the functioning of the media guidance application). For example, the content capture device may include, but is not limited to, a camera (e.g., capable of capturing images and/or videos) and/or a microphone (e.g., capable capturing sound). In some embodiments, the media guidance application may also include a module for operating and/or communicating with the content capture device. For example, the media guidance application may incorporate or access a content capture application used to operate and/or communicate with the content capture device.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

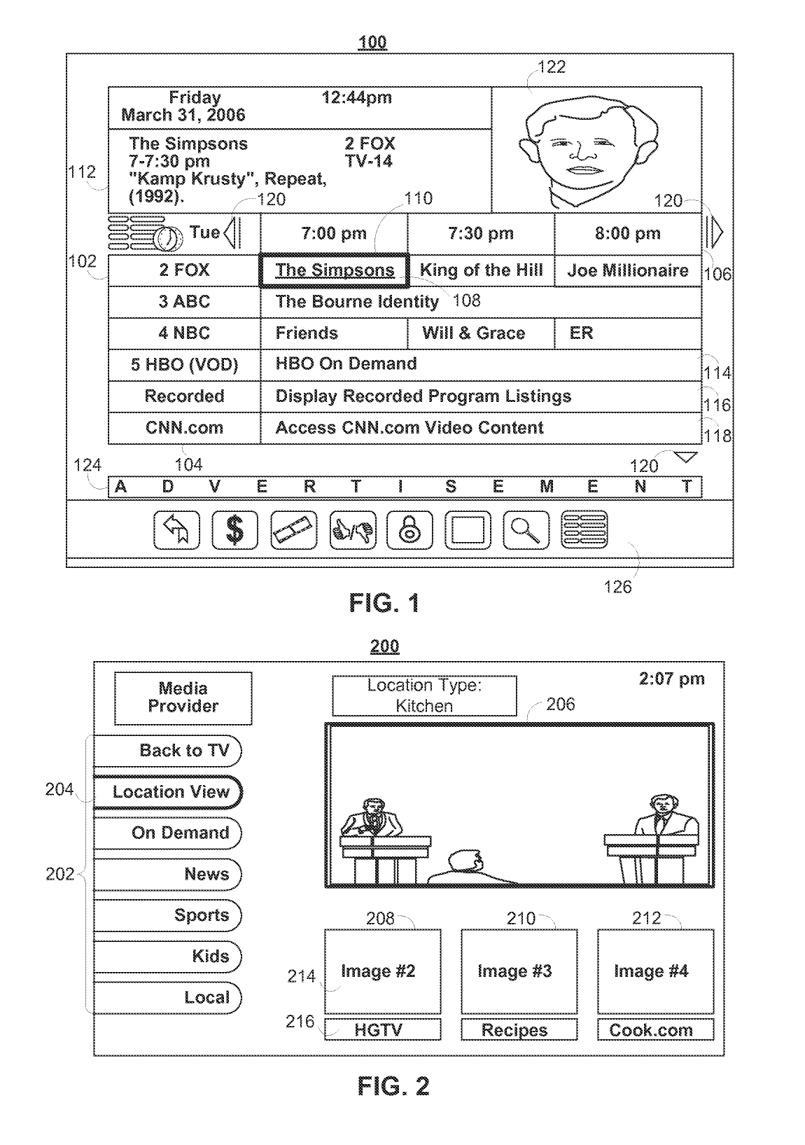

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application.

Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, location view option 204 is selected (e.g., via user input interface 310 (FIG. 3)), thus providing listings 206, 208, 210, and 212, one or more of which may be selected, recommended, and/or transmitted based on the location type of the user device associated with display 200. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. In some embodiments, user equipment device 300 may be a sessile device, which is a non-moving, stationary device (e.g., a television wired to a wall), or user equipment device 300 may be a mobile device (e.g., a smartphone). User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

Data describing the location and/or object at the location may be received by control circuitry 304 via content capture device 316. In some embodiments, the content capture device 316 may incorporate one or more components or sensors (e.g., components or sensors capable of capturing image, audio, video, and/or any other type of data needed for the functioning of the media guidance application). For example, content capture device 316 may include, but is not limited to, a camera (e.g., capable of capturing images and/or videos) and/or a microphone (e.g., capable capturing sound).

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, Xbox SmartGlass, infrared, IEEE 802-11x, etc.), or other short-range communication via wired or wireless paths. BLUETOOTH is a certification mark owned by Bluetooth SIG, INC. Xbox Smartglass is a trademark owned by the Microsoft Corporation. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with media guidance data source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

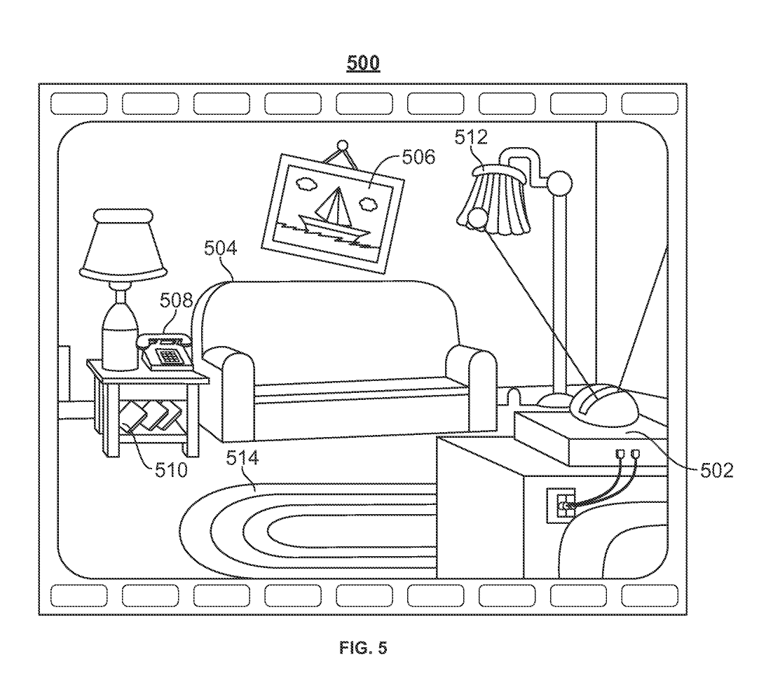

FIG. 5 is an illustrative example of an image of a location of a user equipment device that may be used to select a media asset for presentation to a user based at least in part on the location type in accordance with some embodiments of the disclosure. Image 500 represents data as captured by a content capture device (e.g., content capture device 316 (FIG. 3)).

Image 500 includes several objects (e.g., sofa 504, picture 506, telephone 508, books 510, light fixture 512, floor covering 514, and user equipment device 502). In some embodiments, image 500 may be used by the media guidance application (e.g., processed using a content recognition module incorporated into control circuitry 304 (FIG. 3)) to select a media asset for presentation to a user. For example, by identifying the objects in image 500, the media guidance application may determine the location type associated with the location represented in image 500.

The media guidance application may receive (e.g., via content capture device 316 (FIG. 3)) data (e.g., image 500) describing the location (e.g., a room shown in image 500) of a user device (e.g., user equipment device 502). Upon processing the data (e.g., as discussed below in relation to FIG. 6), the media guidance application may detect objects (e.g., sofa 504, picture 506, telephone 508, books 510, light fixture 512, floor covering 514) at the location. By cross-referencing the detected objects with a database (e.g., a database located at media content source 416 (FIG. 4), media guidance data source 418 (FIG. 4), user equipment 402, 404, and/or 405 (FIG. 4), and/or any device accessible via communications network 414 (FIG. 4)) indicating types of locations in which the detected objects are typically found (e.g., the type of room that typically features one or more of the objects), the media guidance application determines a location type (e.g., a living room) for the location of the user device. The media guidance application then selects, recommends, and/or transmits media assets and/or a type of media asset for the location for presentation to the user.

For example, the media guidance application (e.g., via control circuitry 304 (FIG. 3)) may determine that particular objects (e.g., a crib, children's toys, etc.) at a location indicate a particular location type (e.g., a bedroom) and/or a particular occupant of the location type (e.g., a young child). The media guidance application may also determine to adjust the media assets and/or types of media assets selected, recommended, and/or transmitted based on the objects at the location. For example, upon determining that a location features objects (e.g., picture 506, books 510), which may indicate an interest of a user in particular media assets (e.g., media assets of the same genre/subject matter as picture 506 and/or books 510), the media guidance application (e.g., via instructions issued by control circuitry 304 (FIG. 3)) may adjust the media assets and/or types of media assets selected, recommended, and/or transmitted to be more in line with the interests of the user indicated by the objects.

In some embodiments, the media guidance application may also receive data (e.g., image 500) describing the user device (e.g., user equipment device 502) from a content capture device (e.g., content capture device 316 (FIG. 3)). Upon processing the data (e.g., as discussed below in relation to FIG. 6), the media guidance application (e.g., via control circuitry 304 (FIG. 3)) may determine the operational parameters of the user device as described above. Based on the determined operational parameters, the media guidance application may adjust the media assets and/or types of media assets accordingly.

FIG. 6 is an illustrative example of a data structure that may be used to identify an object in accordance with some embodiments of the disclosure. Data structure 600 may be generated and/or received by the media guidance application. For example, data structure 600 may relate to an image recorded by a content capture device (e.g., content capture device 316 (FIG. 3)) that is being processed using a content recognition module incorporated in, or accessible by, the media guidance application (e.g., incorporated into, or accessible by, control circuitry 304 (FIG. 3)). Data structure 600 may feature the data, which is received by the media guidance application (e.g., from content capture device 316 (FIG. 3)) that describes the location, or objects at the location, of the user equipment device (e.g., user equipment device 502 (FIG. 5)). It should be noted that data structure 600, or any data therein, could be stored, generated, transmitted, and/or received by any of the devices shown in FIGS. 3-4. For example, data structure 600 may be processed by a media guidance application (e.g., via control circuitry 304 (FIG. 3) implemented on user equipment 402, 404, and/or 406 (FIG. 4), media content source 416 (FIG. 4), media guidance data source 418 and/or any device accessible by communications network 414 (FIG. 4).

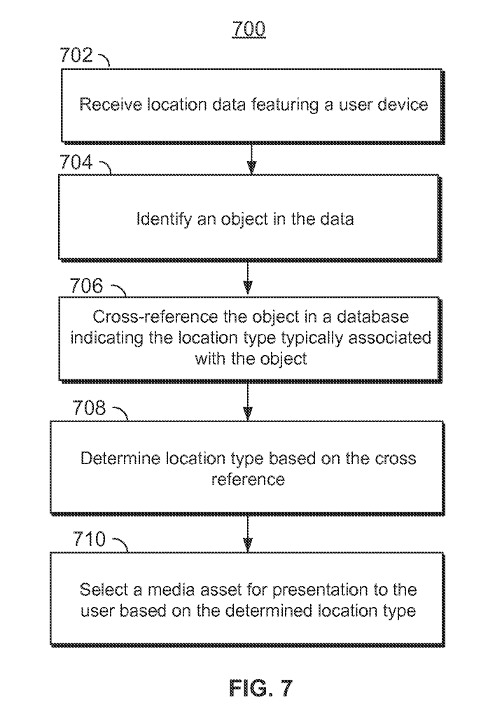

In some embodiments, data structure 600 may be processed by a content recognition module (e.g., incorporated into, or accessible by, control circuitry 304 (FIG. 3)) to determine objects at the location of the user equipment device. For example, the media guidance application may process data structure 600 to identify particular objects at the location of the user equipment device. The identified objects may then be used to determine a location type of the location as described below in FIGS. 7-8.

Data structure 600 includes several fields of code, which may be used by the media guidance application to identify an object (e.g., as described in step 704 (FIG. 7) below) in data (e.g., image 500 (FIG. 5)) received describing the location of a user equipment device (e.g., user device 502 (FIG. 5)). Field 602 indicates to the media guidance application (e.g., according to the processing logic of control circuitry 304 (FIG. 3)) the beginning of data in data structure 600 associated with a location image, and field 622 indicates to the media guidance application the end of data in data structure 600 associated with a location image. For example, field 602 through field 622 indicate to the media guidance application that data structure 600 is associated with an image containing data describing a location of a user equipment device.

Field 604 indicates the position at which the image was captured. In some embodiments, the position at which the image was captured may be used by the media guidance application to determine the location profile (e.g., a location profile stored locally on storage 308 (FIG. 3) of user equipment device 402, 404, and/or 406 (FIG. 4) or remotely on media guidance data source 418 (FIG. 4)) for which this data relates (e.g., as described in relation to FIG. 8 below). In some embodiments, the media guidance application may cross-reference this information with a GPS database (e.g., located at media guidance data source 418 (FIG. 4)) to determine additional information about the location, which may indicate a location type (e.g., whether or not the location is indoors, outdoors, in a private residence, in a public building, etc.).

Additionally or alternatively, the media guidance application may use the position information to add the location to a map of several locations. For example, the media guidance application (e.g., via control circuitry 304 (FIG. 3)) may use this information to generate a mapping (e.g., as described in relation to step 818 (FIG. 8)), which describes the geographical coordinates of the location relative to other locations. In addition this information may be used as an additional factor when selecting media assets and/or types of media assets (e.g., for display on display 100 (FIG. 1) or display 200 (FIG. 2)). For example, the media guidance application may determine that these geographic coordinates are associated with a demographic area that primarily speaks a particular language. Therefore, the media guidance application may select a media asset in that language.

Field 606 through field 620 may indicate to the media guidance application information describing the image of the location. For example, field 606 through field 620 may indicate information about one or more objects located in the image of the location. For example, field 608 through field 618 indicate that an object (e.g., sofa 504 (FIG. 5)) was identified in the image of the location. Field 612 indicates the size of the object. Field 614 indicates the shape of the object, and field 616 indicates the position of the object. The information describing the object may be used by the media guidance application and/or a content recognition module to identify the object described in field 608. For example, the media guidance application may enter the information included in field 610 through field 618 into a lookup table database to determine the type of object (e.g., as described in step 704 (FIG. 7)) indicated in field 608.

It should be noted that the data contained in data structure 600 is exemplarily only, and is not limiting. Additional and/or alternative information may also be displayed in data structure 600 to provide any of the functions described within this disclosure. It should also be noted that although data structure 600 described image data, other types of data (e.g., audio, textual, etc.) may also be transmitted.

FIG. 7 is a flowchart of illustrative steps for selecting a media asset for presentation to a user based at least in part on the location type in accordance with some embodiments of the disclosure. Process 700 may be used to select media assets for presentation (e.g., on display 100 (FIG. 1)) to the user based on the determined location type. It should be noted that process 700 or any step thereof could be displayed on, or provided by, any of the devices shown in FIGS. 3-4. For example, process 700 may be executed by control circuitry 304 (FIG. 3) as instructed by the media guidance application (e.g., implemented on any of the devices shown and described in FIG. 4).

At step 702, the media guidance application receives data (e.g., image 500 (FIG. 5)) associated with a location (e.g., as capture by content capture device 316 (FIG. 3)) that features a user device (e.g., user equipment device 502 (FIG. 5)). In some embodiments, the data may be received from, or generated by, a content capture device, which may be implemented within the user device (e.g., user equipment device 502 (FIG. 5)) at the location. Additionally or alternatively, the content capture device may be implemented in another user device (e.g., a user device other that user equipment device 502 (FIG. 5)). In some embodiments, the data may be received from a remote server (e.g., media guidance data source 418 (FIG. 4)).

At step 704, the media guidance application (e.g., via a content recognition module incorporated into, or accessible by, control circuitry 304 (FIG. 3)) may identify an object in the data. For example, the media guidance application may process the received data (e.g., as described in FIG. 6) to determine particular objects at the location. In some embodiments, processing the data may involve generating a data structure (e.g., data structure 600 (FIG. 6)) associated with the received data. For example, by processing the characteristics (e.g., the size, shape, color, material, etc.) of an object (e.g., as described in relation to field 610 through field 618 of data structure 600 (FIG. 6)) in the received data, the media guidance application may identify (e.g., the type of furniture, the brand of furniture, the production year of the furniture, etc.) the object at the location.

At step 706, the media guidance application (e.g., via control circuitry 304 (FIG. 3)) cross-references the object in a database indicating the location type typically associated with the object. For example, the media guidance application may identify an object in the data (e.g., received from content capture device 316 (FIG. 3)) describing the location of a user device (e.g., user equipment device 502 (FIG. 5)) to be a treadmill. The media guidance application may input “treadmill” into a lookup table database, for example, located on local storage (e.g., user equipment 402, 404, and/or 406 (FIG. 4)) or on remote storage (e.g., media content source 416, media guidance data source 418, and/or any device accessible via communications network 414 (FIG. 4)) to determine the location type in which treadmills are typically found (e.g., public or private gyms and/or fitness centers).

At step 708, the media guidance application determines the location type based on the cross-reference. For example, in the example above, based on the determination that treadmills are typically found in a particular location type (e.g., gyms), the media guidance application (e.g., via control circuitry 304 (FIG. 3)) determines the location type for the location of the user device (e.g., a smartphone currently located in a gym) is the particular location type.

At step 710, the media guidance application (e.g., via instructions issued by control circuitry 304 (FIG. 3)) selects a media asset for presentation to the user based on the determined location type. For example, in the example above, in response to determining that the location type (e.g., a gym) of current location of the user device (e.g., a smartphone) is of a particular type, the media guidance application selects, recommends, and/or transmits media assets and/or types of media assets for presentation to the user (e.g., on display 100 (FIG. 1) or display 200 (FIG. 2)) based on media assets typically viewed in that particular location type (e.g., sports programming, streaming work-out music, and/or advertisements related to sports paraphernalia). In some embodiments, the media guidance application may transmit the determined location type to a remote device (e.g., media guidance data source 418 (FIG. 4)), which may determine the media assets and/or types of media assets appropriate for the determined location.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

FIG. 8 is a flowchart of illustrative steps for analyzing a location image used to select a media asset for presentation to a user based at least in part on the location type in accordance with some embodiments of the disclosure. Process 800 may be used to select media assets for presentation (e.g., on display 312 (FIG. 3)) to the user based on the determined location type. It should be noted that process 800 or any step thereof, could occur on, or be provided by, any of the devices shown in FIGS. 3-4. For example, process 800 may be executed by control circuitry 304 (FIG. 3) as instructed by the media guidance application (e.g., implemented on any of the devices shown and described in FIG. 4).

At step 802, the media guidance application initiates an analysis of a location image. For example, in response to a user input (e.g., entered using user input interface 310 (FIG. 3)) requesting media assets associated with the location of the user device (e.g., via selection of selectable option 204 (FIG. 2)), the media guidance application (e.g., via instructions issued using control circuitry 304 (FIG. 3)), may issue an instruction to a content control device (e.g., content control device 316 (FIG. 3)) to capture data (e.g., image 500 (FIG. 5)) describing the current location of the user device (e.g., user equipment 402, 404, and/or 406 (FIG. 4)). It should be noted that in some embodiments, the media guidance application may also automatically initiate an analysis without receiving a user input.

At step 804, the media guidance application receives data associated with an object in the location image. For example, the media guidance application (e.g., via control circuitry 304 (FIG. 3)), may receive an image (e.g., image 500 (FIG. 5)) featuring one or more objects at a location. In some embodiments, the media guidance application may retrieve a previously captured image featuring one or more objects at a location from local storage (e.g., storage 308 (FIG. 3) located on user equipment 402, 404, and/or 406 (FIG. 4)) and/or remote storage (e.g., a database located on media content source 416 (FIG. 4), media guidance data source 418 (FIG. 4), and/or any device accessible via communications network 414 (FIG. 4)).

At step 806, which in some embodiments may correspond to step 706 (FIG. 7), the media guidance application (e.g., via instructions issued by control circuitry 304 (FIG. 3)) cross-references the one or more objects in location image (e.g., as identified as described in relation to step 704 (FIG. 7)) in a database indicating the location type typically associated with the object. For example, the media guidance application may identify the object in the location image describing the location of a user device (e.g., user equipment 402, 404, and/or 406 (FIG. 4)) to be the Empire State Building. The media guidance application may input “Empire State Building” into a lookup table database, for example, located on local storage (e.g., user equipment 402, 404, and/or 406 (FIG. 4)) or on remote storage (e.g., media content source 416, media guidance data source 418, and/or any device accessible via communications network 414 (FIG. 4)) to determine the location type in which the Empire State Building is typically found (e.g., New York City, mid-town Manhattan, outdoors, cities, etc.).

At step 808, the media guidance application (e.g., via control circuitry 304 (FIG. 3)) determines the location type based on the cross-reference. For example, in response to identifying an object as a washing machine, and determining that washing machines are typically found in laundry rooms, the media guidance application may determine that the user device (e.g., a smartphone currently located in a laundry room) is currently located in a laundry room.

At step 810, the media guidance application (e.g., via control circuitry 304 (FIG. 3)), may determine if there are additional objects in the location image (e.g., image 500 (FIG. 5)). For example, in some embodiments, a content recognition module (e.g., incorporated into or accessible by control circuitry 304 (FIG. 3)) may have detected one or more objects in the location image as indicated by a data structure (e.g., data structure 600 (FIG. 6)), which describes multiple objects. If so, the media guidance application selects a different object at step 812 and returns to step 804. If not the media guidance application proceeds to step 814.

At step 814, the media guidance application updates a location profile based on typical object locations of all objects in the image. For example, in some embodiments, the data received by the media guidance application describing the location may feature several objects that may each be associated with different location types. For example, the media guidance application may determine that a light fixture (e.g., light fixture 512 (FIG. 5)) is located at the location. A light fixture may be associated with many location types. Therefore, the media guidance application may need to create a location profile for the location, which collects data from multiple sources to determine a location type. For example, the media guidance application may have determined an additional object (e.g., a bed) located in the location at step 810. Upon processing the additional object (e.g., via steps 804 through 808, the media guidance application may determine that a location type featuring both a light fixture and a bed has a particular likelihood of being a bedroom. The media guidance application (e.g., via control circuitry 304 (FIG. 3)) may then compare the determined likelihood to a threshold likelihood retrieved from local (e.g., storage 308 (FIG. 3)) or remote storage (e.g., a database located at media guidance data source 418 (FIG. 4)). If the determined likelihood is greater than the threshold likelihood as discussed above, the media guidance application may determine that the location type is a bedroom.

At step 816, the media guidance application (e.g., via control circuitry 304 (FIG. 3)) determines whether or not the location is associated with another image. For example, in some embodiments, the media guidance application may cross-reference position information (e.g., field 604 (FIG. 6)) in a database (e.g., located on storage 308 (FIG. 3), media guidance data source 418 (FIG. 4), and/or any location/device accessible via communications network 414 (FIG. 4)) to determine if the media guidance application has access to another image or other types of data (e.g., additional factors) indicating the location type of the location. If the location is associated with another image, the media guidance application returns to step 802. If the location is not associated with another image, the media guidance application proceeds to step 818.

At step 818, the media guidance application (e.g., via control circuitry 304 (FIG. 3)) determines whether or not the location is associated with mapping data. For example, in some embodiments, the media guidance application may receive data such as one or more images (e.g., image 500 (FIG. 5)) describing multiple locations within a close proximity (e.g., as determined by position information described in relation to FIG. 6 above). The media guidance application may determine (e.g., via control circuitry 304 (FIG. 3)) based on the proximity that the multiple locations constitute a household (e.g., several rooms of a private residence). In addition, the content recognition module (e.g., incorporated into, or accessible by, control circuitry 304 (FIG. 3)) may also locate the boundaries (e.g., the walls, ceilings, floors, doors, etc.) necessary to generate a mapping of one or more locations (e.g., in order to create a blueprint of the household or structure containing several locations).

Based on the boundaries of the multiple locations, the media guidance application may generate a map (e.g., a blueprint of the household) and determine the location types of each location based at least in part on the map. For example, the media guidance application may cross-reference (e.g., via instructions issued by control circuitry 304 (FIG. 3)) the boundary information in a database (e.g., located in storage 308 (FIG. 3), media guidance data source 418 (FIG. 4), and/or any location/device accessible via communications network 414 (FIG. 4)), indicating the location type based on the boundary information (e.g., selecting a location type based on the size and shape of one location in the household relative to the size and shape of another location in the household).

If the media guidance application (e.g., via control circuitry 304 (FIG. 3)) determines the location is associated with mapping data, the media guidance application updates the location profile based on the mapping data at step 820 and proceeds to step 822. If the media guidance application (e.g., via control circuitry 304 (FIG. 3)) determines the location is not associated with mapping data, the media guidance application proceeds directly to step 822.

At step 822, the media guidance application (e.g., via instructions issued by control circuitry 304 (FIG. 3)) selects a media asset for presentation to the user (e.g., for display on display 100 (FIG. 1), display 200 (FIG. 2), and/or display 312 (FIG. 3), based on the location type indicated by the location profile. For example, in the example above, in response to determining that the location type indicated by the location profile (e.g., a kitchen) of the current location of the user device (e.g., user equipment device 402, 404, and/or 406 (FIG. 4)) is of a particular type, the media guidance application selects, recommends, and/or transmits media assets and/or types of media assets for presentation to the user (e.g., on display 100 (FIG. 1) or display 200 (FIG. 2)) based on media assets typically viewed in that particular location type (e.g., cooking programming).

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for displaying content on a user device, the method comprising:
receiving an image of a location of a user equipment device;
identifying an object in the image;
cross-referencing the object to a database indicating location types in which the identified object is typically found;
based at least in part on the cross-reference, determining a location type for the location of the user equipment device; and
selecting a media asset for presentation to a user based at least in part on the location type.

2. The method of claim 1, further comprising:
receiving a plurality of images of a plurality of locations within a household;
determining an association between the plurality of locations within the household based on the plurality of images;
generating a map of the household based on the associations between the plurality of locations;
determining household location types associated with each of the plurality of locations within the household based at least in part on the generated map; and
transmitting media assets to the plurality of locations within the household based at least in part on the household location types.

3. The method of claim 1, further comprising:
receiving an image of the user equipment device;
cross-referencing the image of the user equipment device in a database indicating operational parameters associated with the user equipment device;
based on the cross-reference, determining the operational parameters of the user equipment device; and
selecting media assets for presentation to the user based at least in part on the operational parameters.

4. The method of claim 1, wherein the image of the location of the user equipment device is generated by a content capture application incorporated into the user equipment device.

5. The method of claim 1, further comprising determining content control restrictions based on the location type.

6. The method of claim 1, further comprising:
identifying a likelihood that a particular user is accessing the user equipment device based on the location type for the location of the user equipment device; and
selecting the media asset for presentation to the user based on the identified user.

7. The method of claim 1, wherein the location type is one of a bedroom of an adult, a bedroom of a child, a kitchen, a living room, or a bathroom.

8. The method of claim 1, wherein the object is one of furniture at the location, household goods at the location, decorations at the location, fixtures at the location, and floor coverings at the location.

9. The method of claim 1, further comprising:
identifying the object in the image to be a sofa;
determining sofas are typically found in living rooms;
based on the determination that sofas are typically found in living rooms, determining the location type for the location of the user equipment device is a living room; and
selecting the media asset for presentation to the user based on media assets typically viewed in the living room.

10. The method of claim 1, further comprising:
identifying the object in the image to be a crib;
determining cribs are typically found in rooms of children;
based on the determination that cribs are typically found in rooms of children, determining the location type for the location of the user equipment device is a room of a child; and
selecting the media asset for presentation to the user based on media assets typically viewed in the room of a child.

11. A system for displaying content on a user device, the system comprising control circuitry configured to:
receive an image of a location of a user equipment device;
identify an object in the image;
cross-reference the object to a database indicating location types in which the identified object is typically found;
based at least in part on the cross-reference, determine a location type for the location of the user equipment device; and
select a media asset for presentation to a user based on the location type.

12. The system of claim 11, wherein the control circuitry is configured to:
receive a plurality of images of a plurality of locations within a household;
determine an association between the plurality of locations within the household based on the plurality of images;
generate a map of the household based on the associations between the plurality of locations;
determine household location types associated with each of the plurality of locations within the household based at least in part on the generated map; and
transmit media assets to the plurality of locations within the household based at least in part on the household location types.

13. The system of claim 11, wherein the control circuitry is configured to:
receive an image of the user equipment device;
cross-reference the image of the user equipment device in a database indicating operational parameters associated with the user equipment device;
based on the cross-reference, determine the operational parameters of the user equipment device; and
select media assets for presentation to the user based at least in part on the operational parameters.

14. The system of claim 11, wherein the image of the location of the user equipment device is generated by a content capture application incorporated into the user equipment device.

15. The system of claim 11, wherein the control circuitry is configured to determine content control restrictions based on the location type.

16. The system of claim 11, wherein the control circuitry is configured to:
identify a likelihood that a particular user is accessing the user equipment device based on the location type for the location of the user equipment device; and
select the media asset for presentation to the user based on the identified user.

17. The system of claim 11, wherein the location type is one of a bedroom of an adult, a bedroom of a child, a kitchen, a living room, or a bathroom.

18. The system of claim 11, wherein the object is one of furniture at the location, household goods at the location, decorations at the location, fixtures at the location, and floor coverings at the location.

19. The system of claim 11, wherein the control circuitry is configured to:
identify the object in the image to be a sofa;
determine sofas are typically found in living rooms;
based on the determination that sofas are typically found in living rooms, determine the location type for the location of the user equipment device is a living room; and
select the media asset for presentation to the user based on media assets typically viewed in the living room.

20. The system of claim 11, wherein the control circuitry is configured to:
identify the object in the image to be a crib;
determine cribs are typically found in rooms of children;
based on the determination that cribs are typically found in rooms of children, determine the location type for the location of the user equipment device is a room of a child; and
select the media asset for presentation to the user based on media assets typically viewed in the room of a child.

21-30. (canceled)
